(19) United States
(12) Patent Application Publication
(10) Pub. No.: US 2015/0115940 A1
(43) Pub. Date: Apr. 30, 2015

(54) Position Measuring Device

(71) Applicant: DR. JOHANNES HEIDENHAIN GMBH, Traunreut (DE)

(72) Inventor: Pascal Haible, Trostberg (DE)

(21) Appl. No.: 14/528,000

(22) Filed: Oct. 30, 2014

(30) Foreign Application Priority Data
Oct. 30, 2013 (DE) 10 2013 222 073.1

(51) Int. Cl. G01B 7/02; G01B 7/30

(52) U.S. Cl. CPC G01B 7/023; G01B 7/30
USPC 324/207.23

(57) ABSTRACT

A position measuring device includes a measuring standard that has a first magnetization in a first section for generating a first signal level. The first magnetization is oriented in a first direction, has a first clearance between two adjacent unlike poles, and generates a first maximum of the field strength at the working distance. Furthermore, the measuring standard has a second magnetization in a second section situated next to the first section for generating a second signal level. The second magnetization is oriented in a second direction, has a second clearance between two unlike poles, and generates a first maximum of the field strength at the working distance. The first direction is oriented counter to the second direction, the first clearance is greater than the second clearance, and the first maximum is greater than the second maximum.

### CROSS-REFERENCE TO RELATED APPLICATIONS

The present application claims priority to Application No. 10 2013 222 073.1, filed in the Federal Republic of Germany on Oct. 30, 2013, which is expressly incorporated herein in its entirety by reference thereto.

### FIELD OF THE INVENTION

The present invention relates to a position measuring device, which, for example, includes a measuring standard having magnetization for position-dependent coding. The position-measuring device can be used in angle measuring systems and in length measuring systems.

Corresponding position measuring devices arranged as angle measuring devices are used for measuring rotary motions or rotary positions of a machine component, such as a shaft, on which a measuring standard then is mounted in a rotatably fixed position. The measuring standard, which may also be referred to as an angle scale in this type of use, has a magnetic coding, which is able to be scanned appropriately. The rotary motion is detected, in particular, in absolute terms, so that the measured value that is output is a code word. Position measuring devices of this type are used in machine tools, in particular.

In addition, the position measuring devices can also be used as length measuring systems. In this case, a scale or a cylindrical, e.g., hollow-cylindrical, element having appropriate magnetization may be used as a measuring standard. Here, too, the linear movement may be acquired in absolute terms, for example.

### BACKGROUND INFORMATION

Japanese Published Patent Application No. H09-264760 describes a position measuring device having a magnetic measuring standard, which has magnetized regions for generating a logical value “1” and non-magnetized regions for generating a logical value “0”.

### SUMMARY

Example embodiments of the present invention provide a position measuring device in which a high measuring accuracy may be achieved and which is relatively insensitive with regard to tolerances of the scanning distance.

According to example embodiments of the present invention, a position measuring device includes a measuring standard which has magnetic (north and south) poles along a measuring direction. The position measuring device furthermore has a scanning unit equipped with a sensor. The scanning unit is arranged such that an electrical signal is able to be generated when the measuring standard is scanned along the measuring direction at a working distance, the signal assuming a first signal level or a second signal level depending on the position of the sensor. In a first section, the measuring standard has a magnetization for generating the first signal level, which is oriented at a first field strength in a first direction and has a first clearance between two adjacent unlike poles. Furthermore, this magnetization is provided such that it generates a first maximum of the magnetic field strength at the working distance. In a second section of the measuring standard, which adjoins the first section, the measuring standard also has a magnetization for generating the second signal level, but it is oriented at a second field strength in a second direction and has a second clearance between two adjacent unlike poles. Furthermore, the second magnetization is provided such that it generates a second maximum of the magnetic field strength at the working distance. The first direction is oriented counter to the second direction or antiparallel to the second direction, and in addition, the measuring standard arranged such that the distance between two adjacent unlike poles (N-S; S-N) is greater in the first section than in the second section. At the respective working distance, the maximum of the field strength in the first section is greater than the maximum of the field strength in the second section.

The maxima of the field strengths should therefore be considered at the working distance. This observation is relevant only in one sector of the scanning track or across the width of the scanning track. The strength of the magnetic field can be quantified either by the Ampere per meter unit, or it is also possible to utilize the so-called magnetic flux density for this purpose, which is measured in Tesla. The orientation of the magnetization refers to the field line orientation from the north to the south pole.

The lengths of the first and second sections may correspond to the distances between a north pole and the adjacent south pole in the measuring direction, so that the sections may therefore be delimited by adjacent unlike poles. Viewed geometrically, one and the same pole could represent the delimitation to two sections that are adjacent in the measuring direction.

The first signal level, for example, may be considered the high level, so that the second signal would then be a low level. The high level is able to be processed further as a logical value “1” and the low level consequently as a logical value “0”. Reversed assignments are possible, as well. In other words, the measuring standard has a bit pattern for generating an absolute position, for example. Because of the special magnetization of the measuring standard, it is possible to make the geometrical form of the field lines more uniform, especially the field lines of the first section, so that more precise positions of the transitions from a 1-bit to a 0-bit and from a 0-bit to a 1-bit are detectable than in conventional position-measuring devices.

The scanning unit may include a signal conditioning device and/or a multitude of sensors. The signal conditioning device may be physically present in the housing of the scanning unit or may be disposed separately, i.e., outside the housing.

At least one of the sensors may include a magnetoresistive sensor, which means that the electrical resistance of the sensor is changed by external magnetic fields. Such sensors, for example, may be based on the anisotropic magnetoresistive effect (AMR effect), the giant magneto resistance effect (GMR effect) or the TMR effect.

Furthermore, the sensor, for example, maybe arranged such that it reaches its maximum sensitivity at an orientation of a magnetic field having field lines that are orthogonal to the working distance. In other words, the sensor responds maximally when it is situated in a position in relation to the measuring standard in which the field lines of the magnetic field have an orthogonal orientation with respect to the direction of the working distance. This position is substantially centered between two unlike poles in the measuring direction. In contrast, the sensor responds neither in the direct vicinity of the north pole nor in the direct vicinity of the south pole, because the field lines there are substantially oriented parallel to the working distance. As an alternative, it is possible to use Hall sensors.

The first distance between two adjacent unlike poles in the first section may be at least 1.5 times as large as the second distance in the second section. For example, the distance between two adjacent unlike poles in the first section may be twice as large as in the second section.

The first distance between two adjacent unlike poles in the first section may be n-times as large as the second distance in the second section, n being an even natural number (n=2·k, with k=1, 2, 3 . . . ). In particular, n may assume the value 2 (k=1).

The measuring standard may be arranged such that different distances (N-N; S-S) exist between two like poles in predefined sections of the measuring standard. More specifically, in a section for generating the first signal level, the measuring standard may have a different (especially larger) clearance between like poles than in a section of the measuring standard that has a magnetization for generating the second signal level.

The measuring standard may have a third section, which is situated between two second sections and does not have any magnetization itself. In this case the first distance may be at least r times as large as the second distance, r being a real number that is greater than 1.

The position measuring device may include a measuring standard arranged as a linear scale for measuring a length. As an alternative, the measuring scale may be arranged as an angle scale for measuring an angle. In this case, the measuring standard may have a cylindrical form, so that the magnetization is produced on the lateral surface of the cylinder or the coding is situated on the lateral surface of the cylinder. On the other hand, in a measuring standard arranged as an angle scale in the form of a cylinder, the magnetization may also be produced on an end face of the cylinder.

Further features and aspects of example embodiments of the present invention are described in more detail below with reference to the appended Figures.

### BRIEF DESCRIPTION OF THE DRAWINGS

FIG. 1 schematically illustrates a position measuring device and a signal characteristic according to an example embodiment of the present invention.

FIG. 2 schematically illustrates a position measuring device and a signal characteristic according to an example embodiment of the present invention.

### DETAILED DESCRIPTION

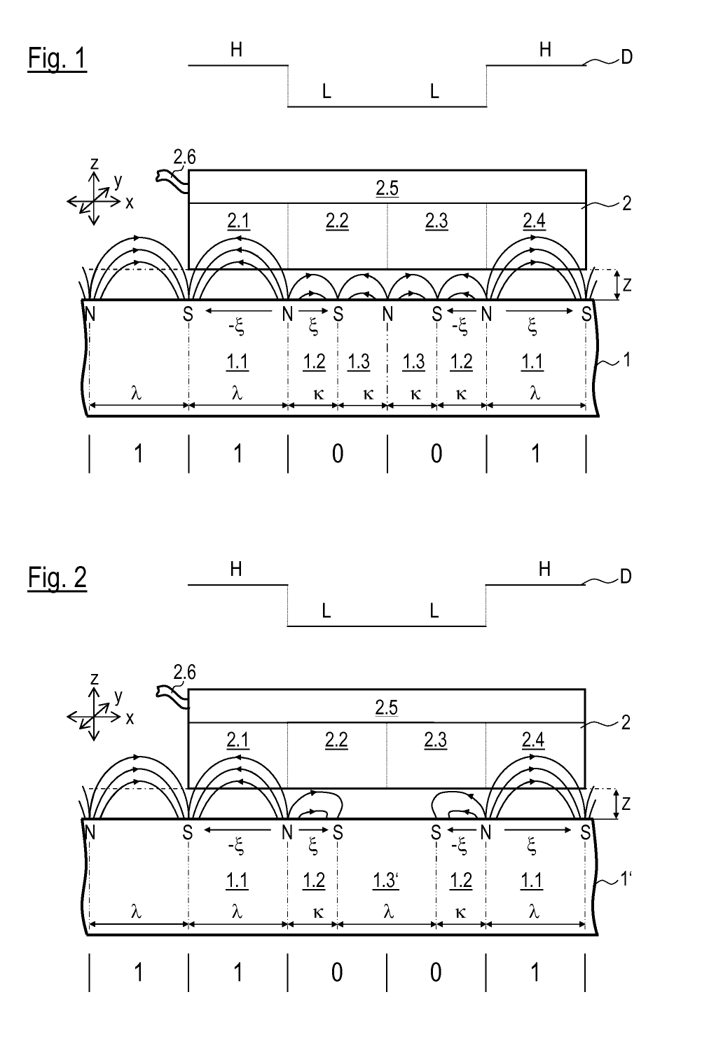

As schematically illustrated in FIG. 1, a position measuring device includes a measuring standard 1. In the exemplary embodiment illustrated, measuring standard 1 is made of ferromagnetic material, such as an alloy including the components iron, chromium, cobalt, and molybdenum. Measuring standard 1 is preferably mounted on a support body, such as a ring or a rod.

To achieve coding of measuring standard 1, it is magnetized such that north and south poles N, S are provided in alternation along a measuring direction x. The produced magnetization is therefore a permanent magnet magnetization. As a rule, this produces a bit pattern which has a constant length λ of the individual bits 0, 1 across measuring direction x. In first sections 1.1 of measuring standard 1, the magnetization is provided such that bits having the value “1” are read out there, whereas in the second and third sections 1.2, 1.3 of measuring standard 1, bits having the value “0” are read out. First sections 1.1 are disposed adjacently to a second section 1.2 in each case, or abut a second section 1.2. In addition, the length of the first and second sections 1.1, 1.2 in the example illustrated equals the distance of adjacent, especially unlike, poles N, S in the x direction.

The magnetization in first sections 1.1 of measuring standard 1 has a first direction ξ; −ξ featuring a first, relatively high field strength. In second sections 1.2, which are situated adjacently to a first section 1.1 in each case, a magnetization in a second direction −ξ; ξ featuring a second, lower field strength is implemented, the first direction ξ; −ξ being oriented counter to the second direction −ξ; ξ.

The distances between a north pole N and an adjacent south pole S in measuring direction x in the respective first section 1.1 are larger than the distances between a north pole N and an adjacent south pole S in the respective second section 1.2. These distances are also referred to as spatial frequency, so that a lower spatial frequency is applied in first sections 1.1 than in second sections 1.2. The space between unlike poles N, S in first section 1.1 has length λ, and in second and third sections 1.2, 1.3 this length is κ, the relation κ=λ/2 or λ=2·κ applying in this context. In particular, lengths λ, κ of first, second and third sections 1.1, 1.2, 1.3 are equal to the spaces between a north pole N and adjacent south pole S in measuring direction x. In the y-direction the magnetization or code track extends across a predefined width that corresponds at least to the width of the scanning track.

The position measuring device moreover includes a scanning unit 2. It is located at a working distance Z relative to measuring standard 1, which is oriented parallel to the z direction and orthogonally with respect to measuring direction x. In the exemplary embodiment illustrated, scanning unit 2 includes four sensors 2.1, 2.2, 2.3, 2.4, which are arranged as magnetoresistive sensors in this instance. Sensors 2.1, 2.2, 2.3, 2.4 therefore convert the magnetic fields of measuring standard 1 into electrical raw signals which are transmitted to a signal conditioning device 2.5 or an electronic circuit. The raw signals are used to generate digital signals D, which assume either the signal level H or signal level L.

In a plane (x, y plane) that has an orthogonal orientation with respect to the z direction and lies at a working distance Z from measuring standard 1, the maximum of the magnetic field strength generated by the magnetization in first section 1.1 is greater than the maximum of the magnetic field strength triggered by the magnetization in second section 1.2. Because of these different field strengths or maxima in working distance Z, sensors 2.1 and 2.4 will therefore generate signal level H when sweeping first sections 1.1, while sensors 2.2 and 2.3 generate signal level L when located at working distance Z in relation to second and third sections 1.2, 1.3. This behavior may be achieved by either adapting sensors 2.1, 2.2, 2.3, 2.4 and the field strengths to each other such that sensors 2.1, 2.2, 2.3, 2.4 are indeed detecting the magnetic field of sections 1.1, but have no sensitivity for the reduced field strength of second and third sections 1.2, 1.3. As an alternative, signal conditioning device 2.5 may also digitize the different raw signals if sensors 2.1, 2.2, 2.3, 2.4 respond to all magnetic fields of sections 1.1, 1.2, 1.3 with different response strengths.

The sensors are arranged to achieve their maximum sensitivity at an orthogonal orientation of the magnetic field lines with respect to the z direction, i.e., when the field lines are aligned in parallel with measuring direction x in the present case. As a result, sensors 2.1, 2.2, 2.3, 2.4 generate a maximum level in their raw signals when they are at working distance Z in measuring direction x, centered between two unlike poles N, S. On the other hand, the raw signals are minimal when the sensors are situated in the immediate vicinity of a north pole or a south pole, because the field lines there are substantially oriented in the z direction.

The use of signal D generated in this manner makes it possible to form a code word, such as 1001 in this instance, i.e., made up of four bits, which provides information about the absolute relative position between scanning unit 2 and measuring standard 1. Scanning unit 2 may be arranged such that it has greater length in the x direction than illustrated, so that much longer code words are able to be generated, as well. Signal D is transmittable to sequential electronics via a cable 2.6.

In a further example embodiment, as schematically illustrated in FIG. 2, a measuring standard 1′ has third sections 1.3′, which are not magnetized. Although the field lines of sections 1.2 are thereby deformed in contrast to those in the exemplary embodiment illustrated in FIG. 1, this is unimportant for the scanning of measuring standard 1′, because the magnetic field at working distance Z for sections 1.2, 1.3′ lies below the response threshold of sensors 2.1 to 2.4. Third section 1.3′ has length κ, and the relation κ=λ/2 or λ=2·κ applies here, as well.

Although measuring standards 1, 1′ according to FIGS. 1 and 2 are shown in linear form, it should be understood that linear position measuring systems are merely illustrative. For example, the measuring standard may be arranged as an angle scale, such that FIGS. 1 and 2 may also be interpreted to mean that measuring standards 1, 1′ are also arranged as cylindrical disks, on whose end faces a magnetization or code is provided in each case, so that scanning unit 2 is situated at an axial working distance Z in relation to particular measuring standards 1, 1′.

The arrangement or placement of sensors 2.1 to 2.4 is illustrated in simplified form in FIGS. 1 and 2. For example, it is also possible that more sensors than illustrated are used, in which case the sensors may be positioned such that they ensure scanning that overlaps in the x direction, and, for example, a single sensor perhaps scans only an area having a length of λ/2.

What is claimed is:

1. A position measuring device, comprising:
a measuring standard including magnetic poles arranged along a measuring direction; and
a scanning unit including a sensor and adapted to generate an electrical signal when the measuring standard is scanned at a working distance along the measuring direction;
wherein the measuring standard includes a first magnetization in a first section to generate a first signal level of the electrical signal, the first magnetization being oriented in a first direction, having a first clearance between two adjacent, unlike poles, and being adapted to generate a first maximum of magnetic field strength at the working distance;
wherein the measuring standard includes a second magnetization, to generate a second signal level of the electrical signal, in a second section located adjacent to the first section, the second magnetization being oriented in a second direction, having a second clearance between two adjacent, unlike poles, and being adapted to generate a second maximum of the magnetic field strength at the working distance; and
wherein the first direction is oriented counter to the second direction, the first clearance is greater than the second clearance, and the first maximum is greater than the second maximum.

2. The position measuring device according to claim 1, wherein the sensor includes a magnetoresistive sensor.

3. The position measuring device according to claim 1, wherein the sensor is adapted to achieves maximum sensitivity at an orientation of a magnetic field featuring field lines that are orthogonal to the working distance.

4. The position measuring device according to claim 1, wherein the first clearance is at least 1.5 times as large as the second clearance.

5. The position measuring device according to claim 1, wherein the first clearance is at least n times as large as the second clearance, n being an even natural number.

6. The position measuring device according to claim 5, wherein n is 2.

7. The position measuring device according to claim 1, wherein the measuring standard includes a third section arranged between two second sections and having no magnetization.

8. The position measuring device according to claim 1, wherein the measuring standard has different clearances between two like poles.

9. The position measuring device according to claim 1, wherein the measuring standard is arranged as an angle scale.

10. The position measuring device according to claim 9, wherein the measuring standard is arranged as a cylinder and the magnetization is provided on a lateral surface of the cylinder.
